(19) United States
(12) Patent Application Publication
(10) Pub. No.: US 2026/0028877 A1
(43) Pub. Date: Jan. 29, 2026

(54) LOUVER SYSTEMS FOR A PANEL OF A MOVABLE BARRIER

(71) Applicant: OVERHEAD DOOR CORPORATION, Lewisville, TX (US)

(72) Inventor: Bradley J. Lee, Arlington, TX (US)

(21) Appl. No.: 18/780,903

(22) Filed: Jul. 23, 2024

(51) Int. Cl. E06B 9/36; E06B 3/70

(52) U.S. Cl. CPC E06B 9/368; E06B 3/70; E06B 2003/7044

(57) ABSTRACT

A louver system for a panel of a movable barrier may include a first louver carried on the panel of the movable barrier and including a first slat portion and a first pivot base. A second louver may be carried on the panel of the movable barrier and offset from the first louver, the second louver including a second slat portion and a second pivot base. A gear train may be coupled to the first pivot base and the second pivot base. The gear train may be configured to simultaneously rotate the first louver and the second louver between an open configuration and a closed configuration. A motor may be carried on the movable barrier and configured to drive the gear train to simultaneously rotate the first louver and the second louver.

### TECHNICAL FIELD

The present disclosure relates generally to movable barrier systems and, more particularly, to movable barrier systems that include louver systems, devices, and/or methods for adjusting the restriction of light and/or viewing through a window and/or an opening in a movable barrier system.

### BACKGROUND

A window of a movable barrier often may consist of glass panels made of permanently installed glass that is, for example, clear, transparent with special coatings, translucent, semi-translucent, and/or opaque. In some cases, adjustable window treatments (e.g., window treatments that change from clear to opaque and/or restricted viewing treatments) may be preferred for various reasons, such as varying light levels and/or privacy concerns. However, adjustable window treatments may often be ineffective due to high cost or low durability. Thus, there remains a need for effective ways to adjust the restriction of light and/or viewing through a window and/or an opening in a movable barrier system.

### SUMMARY

Embodiments of the present disclosure include systems, devices, and methods of adjusting the restriction of light and/or viewing through a window and/or an opening in a movable barrier system.

In some examples, a louver system for a panel of a movable barrier may include a first louver carried on the panel of the movable barrier and including a first slat portion pivotable about a first axis. The louver system may further include a second louver carried on the panel of the movable barrier and offset from the first louver, the second louver including a second slat portion pivotable about a second axis. The louver system may further include a gear train configured to simultaneously rotate the first louver about the first axis and the second louver about the second axis between an open configuration and a closed configuration. The louver system may further include a motor carried on the movable barrier and configured to drive the gear train to simultaneously rotate the first louver and the second louver.

In some examples, a movable barrier system may include a movable barrier panel including a first rail and a second rail, the second rail being disposed at a position spaced a distance apart from the first rail. The movable barrier system may further include a first louver coupled to the second rail and including a first slat portion and a first pivot base. The movable barrier system may further include a second louver coupled to the second rail and offset from the first louver, the second louver including a second slat portion and a second pivot base. The movable barrier system may further include a gear train coupled to the first pivot base and the second pivot base, the gear train configured to simultaneously rotate the first louver and the second louver between an open configuration and a closed configuration. The movable barrier system may further include a motor carried on the first rail and configured to drive the gear train to simultaneously rotate the first louver and the second louver.

In some examples, a method for adjusting a louver system for a panel of a movable barrier may include positioning a first louver on the panel of the movable barrier, the first louver including a first slat portion pivotable about a first axis. The method may further include positioning a second louver on the panel of the movable barrier offset from the first louver, the second louver including a second slat portion pivotable about a second axis. The method may further include coupling a gear train to the first louver and the second louver, the gear train configured to simultaneously rotate the first louver and the second louver between an open configuration and a closed configuration. The method may further include positioning a motor on the movable barrier, the motor configured to drive the gear train to simultaneously rotate the first louver and the second louver. The method may further include sending a signal to a controller to cause the motor to drive the gear train to simultaneously rotate the first louver and the second louver.

Additional aspects, features, and advantages of the present disclosure will become apparent from the following detailed description.

### BRIEF DESCRIPTION OF THE DRAWINGS

The accompanying drawing figures incorporated in and forming a part of this specification illustrate several aspects of the disclosure, and together with the description, serve to explain the principles of the disclosure.

FIG. 1 is a perspective view of an example movable barrier system, according to some aspects of the present disclosure.

FIG. 2 is a front perspective view of an example louver assembly of a movable barrier system, according to some aspects of the present disclosure.

FIG. 3 is a cross-sectional front perspective view of an example louver assembly, according to some aspects of the present disclosure.

FIG. 4 is a front perspective view of an example louver, according to some aspects of the present disclosure.

FIG. 5 illustrates an example block diagram of an example louver operator system, according to some aspects of the present disclosure.

FIG. 6 illustrates an example method of adjusting a louver assembly of a movable barrier. This may include adjusting the louver assembly to restrict light and/or visibility through a window and/or an opening in a movable barrier system, according to some aspects of the present disclosure.

FIG. 7 is an exploded front perspective view of an example louver assembly, according to some aspects of the present disclosure.

### DETAILED DESCRIPTION

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

Disclosed herein are louver systems, methods, and devices for adjusting the amount of light and/or visibility through a window and/or an opening in a movable barrier system. This may be done manually, remotely, and/or automatically. A louver assembly may be efficiently incorporated and made compatible with a movable barrier system. Thus, the present disclosure allows for an adjustable louver assembly which may restrict light and/or viewing through a movable barrier, thereby inexpensively, efficiently, and/or effectively preventing or limiting the access of light and/or visibility into an interior space.

In some implementations, as discussed in detail further herein, a movable barrier system may include a louver assembly and corresponding operator system integrated with a movable barrier, such as an aluminum full view garage door. In some implementations, the louver assembly, a controller, and a motor may be positioned on a section panel to drive fluid movements and transitions of the section panel and louver assembly while permitting the movable barrier to still open and close. When the movable barrier is at least partially closed, the louver assembly may adjustably limit or prevent access of light and/or visibility into an interior space providing numerous benefits such as increased comfort, interior visibility, privacy, and/or security.

The louver assembly may include one or more louvers which may be rotated using a gear train actuated by the operator system. The operator system may be controlled by a user interface, one or more sensors, a timer, and/or any other device capable of sending a signal. The operator system may include a controller and a motor which may be actuated by the controller. In some implementations, at least a portion of the operator system may be positioned directly onto a section panel such that the controller and the motor are positioned substantially adjacent to the louver assembly. The motor may cause at least a portion of a gear train to induce the one or more louvers to rotate between different positions such as from a closed configuration to an open configuration or from an open configuration to a closed configuration. The gear train may engage and rotate the one or more louvers such that the movement of the one or more louvers is coordinated between positions.

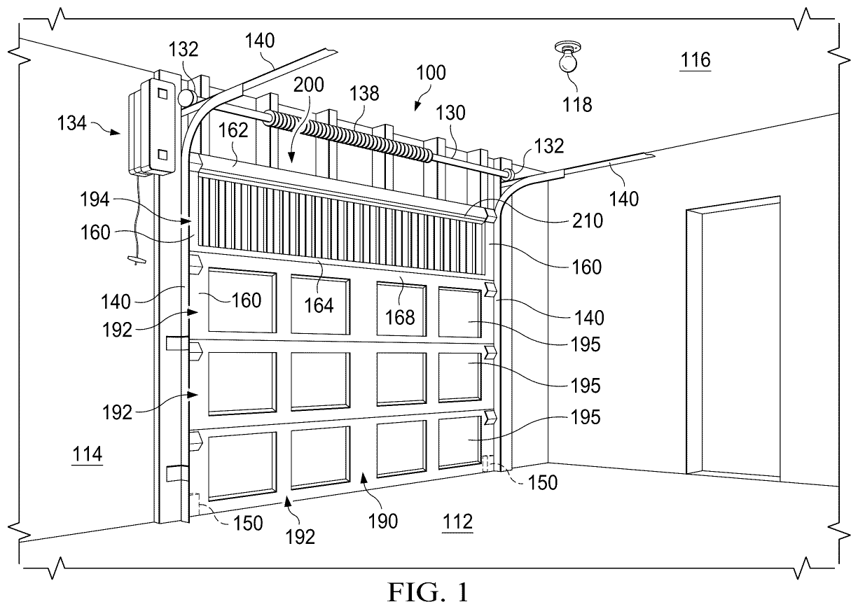

FIG. 1 is a perspective view of an example movable barrier system, according to some aspects of the present disclosure. FIG. 1 illustrates a movable barrier 190 and a barrier operator 134. In this example, the movable barrier 190 may be an upward acting garage door. In some examples, the movable barrier 190 may be a sectional-type garage door. The movable barrier 190 may include various panels including opaque, transparent, or semi-transparent panels.

In some implementations, the movable barrier system 100 described herein may be referred to as a barrier system, a door system, a garage door system, a gate system, or any other similar term. In some implementations, the movable barrier 190 may be referred to as a barrier, a door, a garage door, a sectional garage door, an upward acting garage door, a gate, a movable gate, a sliding gate, or any other similar term. In some implementations, the barrier operator 134 may alternatively be referred to as an operator, a door operator, a garage door operator, a gate operator, an opener, a door opener, a garage door opener, a gate opener, a control system, or any other similar term.

FIG. 1 shows that the movable barrier 190 provides access to a space or a room having a floor 112. The movable barrier 190 may provide selective access to the space. In the closed position shown in FIG. 1, the movable barrier 190 may be positioned within an opening of a wall, such as wall 114. The barrier operator 134 may be any suitable type of barrier operator. For example, in some implementations, the barrier operator 134 may be a jackshaft operator. In other implementations, the barrier operator 134 may be a trolley operator, a direct drive wall or ceiling mounted operator, a belt driven operator, a chain driven operator, a screw drive operator, and/or any other type of barrier operator. The barrier operator 134 may include any suitable components. As shown in FIG. 1, the barrier operator 134 may be disposed adjacent to the movable barrier 190. For example, in the implementation shown, the barrier operator 134 may be positioned on the wall 114. However, the barrier operator 134 may be positioned at any other location within the room shown in FIG. 1. For example, the barrier operator 134 may be affixed to the ceiling 116. In some implementations, the barrier operator 134 may be positioned on a different wall of the room or on the floor 112 of the room. In some implementations, particularly in an implementation in which the barrier operator 134 is affixed or otherwise positioned on the ceiling 116 of the room, the light fixture 118 shown may be attached to, or a part of, the barrier operator 134.

Any suitable structures or components may be implemented to facilitate movement of the movable barrier 190 between a closed position and an open position. In the example shown in FIG. 1, the movable barrier 190 may be moved along one or more tracks 140.

FIG. 1 illustrates the movable barrier 190 as an upward acting sectional door being movable between open and closed positions along the tracks 140. Tracks 140 may be affixed to either side of the opening that is covered by the movable barrier 190. In some implementations, the tracks 140 may be affixed to the wall 114 shown in FIG. 1 and/or the ceiling 116. In some implementations, the movable barrier 190 may include one or more rolling or sliding components on either side sized and shaped to fit within and move in a longitudinal direction along the tracks 140. The rolling or sliding components may be affixed to brackets positioned on either side of the movable barrier 190.

Components of the movable barrier system 100 shown in FIG. 1 may include any other suitable components. For example, the movable barrier system 100 may include rollers positioned on the movable barrier 190 or the tracks 140. The movable barrier system 100 may include additional sensors, such as safety sensors able to detect the presence or motion of an object or person and/or seals positioned along any portion of the movable barrier 190 or the corresponding opening, rails, cables, and/or tube shafts. The system may include extension springs to further reduce necessary rotational force of a motor, a motor rail, belts, motor head, motor arms, lift handles for manual operation, emergency release ropes, and/or any other suitable components.

In some implementations, the movable barrier system 100 may additionally include cable drum assemblies 132, a torsion tube 130, and a torsion spring assembly 138. The movable barrier system 100 may additionally include a cable (not shown) attached to the cable drum assemblies 132 and connectors 150 which form a part of the movable barrier 190. In some implementations, the barrier operator 134 may include a motor or similar component which may automatically open and/or close the movable barrier 190 by rotating the torsion tube 130 in a first direction and/or in a second direction. It should be understood that as used herein, the term torsion tube 130 includes hollow tubes as well as solid shafts and bars.

In some implementations, the movable barrier 190 may include one or more sections 192, 194. In the example shown in FIG. 1, the movable barrier 190 may include one or more sections 192, 194 including at least some or all of panes 195, stiles 160, upper rails 162, 168, and/or lower rails 164. It should be understood that the sections 192, 194 may be referred to by other terms such as section panel, panel, frame, section pan, pan, and/or any other suitable term. In the example shown in FIG. 1, section 194 may include an upper rail 162 and a lower rail 164 and may further include a louver assembly 200. The louver assembly may include one or more adjustable louvers. In some implementations, the louver assembly 200 may be referred to by other terms such as a louver system, an adjustable louver assembly, an adjustable louver system, a louvered window, a jalousie window, a jalousie, a jalosy, and/or any other suitable term. While in the example of FIG. 1, only section 194 includes a louver assembly 200, it should be understood that in some implementations, some or all of sections 192 could include louver assemblies 200. In some implementations, the rail 164 may couple with and/or be hingedly connected to the rail 168. In some implementations, the rail 162 may be referred to as a first rail. In some implementations, the rail 164 may be referred to as a second rail. In some implementations, the louver assembly 200 may be directly integrated into a section 192, 194 of the movable barrier 190. In some implementations, the louver assembly 200 may be a subassembly that may be coupled to a section 192, 194 of the movable barrier 190. Depending on the implementation, the louver assembly 200 may or may not be installed in association with a glass panel or other translucent or semi-translucent panel. In implementations in which the louver assembly 200 is a subassembly, the louver assembly 200 may be positioned either internal or external to a glass panel or other translucent or semi-translucent panel depending on the implementation.

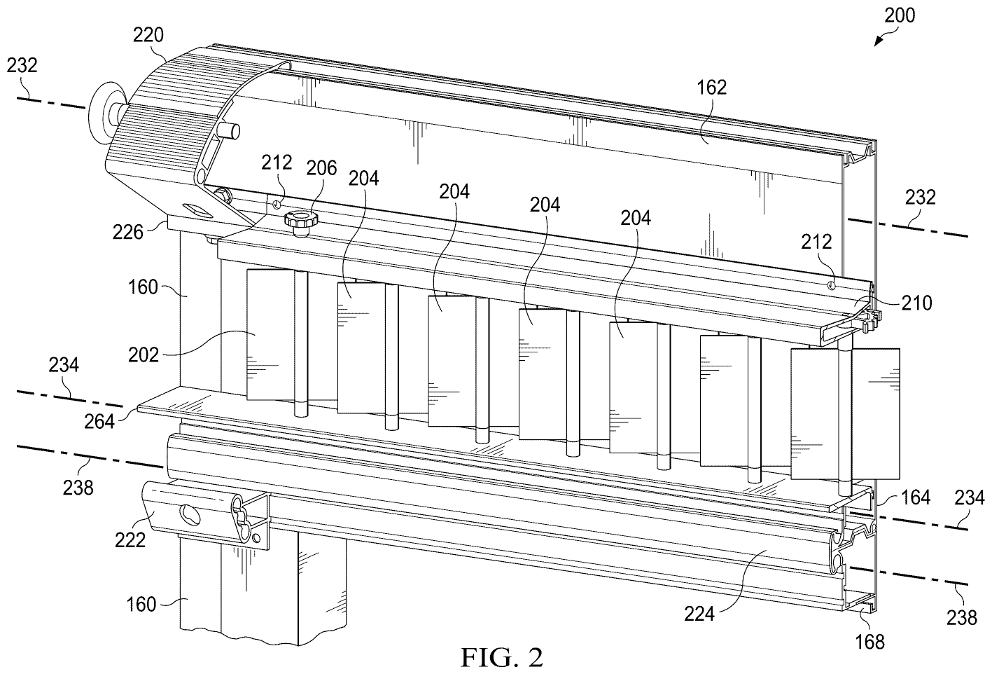

FIG. 2 is a front perspective view of an example louver assembly 200, according to some aspects of the present disclosure. Further, FIG. 2 may illustrate a portion of two panels 192, 194 of a movable barrier 190. The louver assembly 200 may include a first panel 194 which may include at least one stile 160, a first rail 162, and a second rail 164. Stile 160 may couple with the first rail 162 and the second rail 164. In some implementations, a lengthwise axis of stile 160 may be wholly or substantially perpendicular to a lengthwise axis 232 of the first rail 162 and/or a lengthwise axis 234 of the second rail 164. In some implementations, the lengthwise axis 232 of the first rail 162 may be wholly or substantially parallel to the lengthwise axis 234 of the second rail 164. In some implementations, the second rail 164 may be coupled to a third rail 168 of a second panel 192. The second rail 164 may be coupled to the third rail 168 by any mechanism, such as a hinge 224. In some implementations, the second rail 164 may be coupled to the third rail 168 by a geared hinge 224, but it should be understood that the second rail 164 and the third rail 168 could be coupled by any type of hinge, such as a barrel hinge, butt hinge, spring-loaded hinge, concealed hinge, overlay hinge, strap hinge, ball-bearing hinge, offset hinge, scissor hinge, continuous hinge, and/or double-action spring hinge. A first bracket 220 may be coupled to the first rail 162 and/or to a third bracket 226. In some implementations, the first bracket 220 and/or the third bracket 226 may be coupled to a stile 160. A second bracket 222 may be coupled to the third rail 168. The third bracket 226 may be coupled to the first rail 162. Depending on the implementation, any bracket 220, 222, 226 may be coupled to any part of any panel 192, 194 using any attachment mechanism such as fasteners, mechanical attachment, adhesive, glue, and/or any other type of mechanism. It should be understood that any embodiment using a fastener may include any type of fastener such as a screw, a bolt, an anchor, a rivet, a nail, and/or any other type of fastener.

In some implementations, the louver assembly 200 may further include a first louver 202, one or more secondary louvers 204, a knob 206, and a housing 210. The second rail 164 may further comprise a first portion 264 projecting horizontally outward, and forming a surface. In some implementations, the first louver 202 and/or any or all of the one or more secondary louvers 204 may be made of extruded aluminum; however, it should be understood that, depending on the implementation, the first louver 202 and/or any or all of the one or more secondary louvers and/or any other element included in the louver assembly 200 may be made of any material such as aluminum, iron, steel, metal, alloy, plastic, wood, and/or ceramic. In the example shown in FIG. 2, the louvers 202, 204 are positioned in a vertical arrangement. However, it should be understood that in some implementations, the louvers 202, 204 may be arranged horizontally or diagonally.

The first louver 202 may be positioned adjacent to the housing 210 and, in some implementations, at least a portion of the first louver 202 may be positioned within the housing 210. The first louver 202 may be coupled to the first portion 264. In some implementations, the first louver 202 may be configured to rotate with respect to the first portion 264 when the knob 206 is rotated. The knob 206 may be located and actuated from the top of the louver assembly 200 or the bottom of the louver assembly 200. In some implementations, the first louver 202 and the knob 206 may rotate at the same angular velocity relative to the first portion 264.

In some implementations, the louver assembly 200 may rotate from a closed configuration to or toward an open configuration or from an open configuration to or toward a closed configuration. In some configurations such as a closed configuration, the one or more louvers 202, 204 may be angled at a first angle with respect to the lengthwise axis 232 of the first rail 162, the lengthwise axis 234 of the second rail 164, and/or a lengthwise axis 238 of the third rail 168 of the movable barrier 190. In some implementations, the first angle may equal 0 degrees. In some configurations such as an open configuration, the one or more louvers 202, 204 may be angled at a second angle with respect to the lengthwise axis 232 of the first rail 162, the lengthwise axis 234 of the second rail 164, and/or the lengthwise axis 238 of the third rail 168 of the movable barrier 190. The first angle may have an angle measure less than the second angle. In some implementations, the one or more louvers 202, 204 may be positioned at any offset angle relative to the lengthwise axis 232 of the first rail 162, the lengthwise axis 234 of the second rail 164, and/or the lengthwise axis 238 of the third rail 168 of the movable barrier 190 such that the louver assembly may shift continuously or pausing at discrete intervals between louver positions.

One or more secondary louvers 204 may be positioned adjacent to the housing 210 and, in some implementations, at least a portion of the one or more secondary louvers may be positioned within the housing 210. The one or more secondary louvers may be coupled to the first portion 264. In some implementations, the one or more secondary louvers may be configured to rotate with respect to the first portion 264 simultaneously with the first louver 202 when the knob 206 is rotated. In some implementations, the one or more secondary louvers 204, the first louver 202, and/or the knob 206 may rotate at the same angular velocity relative to the first portion 264. In some implementations, the louver assembly 200 may include a first louver 202 and one secondary louver 204, which may also be referred to as a second louver. Further, in some implementations disclosed herein, an implementation may be discussed in association with a first louver 202 and one second louver 204, but it should be understood that this is merely done for simplicity and that any implementation disclosed herein may include any number of secondary louvers 204. In some implementations, the louver assembly 200 may include six secondary louvers 204.

In some implementations, the housing 210 may be coupled to the first rail 162 and/or the bracket 226 with fasteners 212. It should be understood that the fasteners 212 may be any type of fastener such as a screw, a bolt, an anchor, a rivet, a nail, and/or any other type of fastening mechanism. The housing 210 may be configured to at least partially house a mechanism configured to cause the first louver 202 and/or the one or more secondary louvers 204 to rotate.

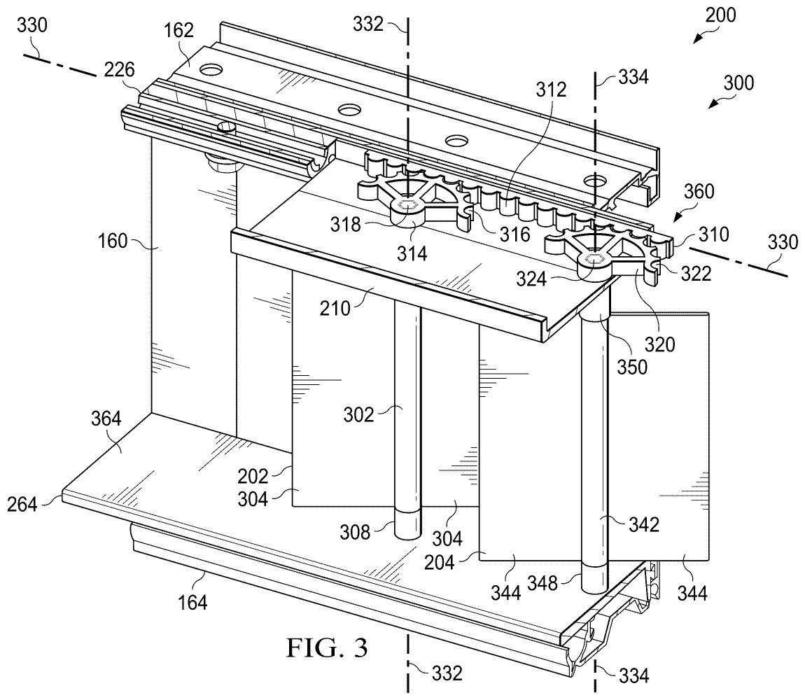

FIG. 3 is a cross-sectional front perspective view of an example louver assembly, according to some aspects of the present disclosure. FIG. 3 illustrates a cross-sectional view 300 of the louver assembly 200 to at least further illustrate any mechanism positioned at least partially within the housing 210. In some implementations, the louver assembly 200 may further include at least one gear train 360, which may also be referred to as a drive train. In some implementations, the louver assembly 200 and gear train(s) 360 may be configured with the gear train 360 positioned on top or in an upper position of the louver assembly 200 while in other implementations, they may be configured with the louver assembly 200 and gear train(s) 360 inverted with the gear train 360 positioned on the bottom or lower position of the louver assembly 200. In some implementations, the one or more louvers 202, 204 may be mounted horizontally with the gear train(s) 360 positioned on the left and/or the right sides of the louver assembly 200. The gear train 360 may be configured such that the rotation of one louver 202 may induce coordinated rotation of other louvers 204 in the louver assembly 200. Thus, the gear train 360 may be configured to simultaneously rotate the first louver 202 and the one or more secondary louvers 204 between an open configuration and a closed configuration. The gear train 360 may be coupled to a first pivot base 302 (shown as a first rod portion) of the first louver 202 and a pivot base 342 (shown as a second rod portion) of the second louver 204. In some implementations, the gear train 360 may include a first gear 314, a second gear 320, and/or a third gear 310. It should be understood that for the purposes of this disclosure, “gear” may be defined as any body configured to mechanically engage with another body, and may include any body configured to mechanically mesh with another body. Thus, it should be understood that “gear” may refer to any body such as any type of sprocket, pinion, cam, rack, belt, chain, and/or any other type of body including at least one cog and/or tooth and/or valley. In some implementations, an upper portion of the housing 210 may be removably coupled to a lower portion of the housing 210 to allow for easier assembly of the gear train 360.

In the example shown in FIG. 3, the third gear 310 may be a translating body such as a rack which may include one or more cog 312. It should be understood that, depending on the embodiment, the one or more cog 312 may also be referred to as one or more tooth. The rack 310 may be configured to translate along a translation axis 330. In some implementations, the translation axis 330 may be wholly or substantially parallel to the lengthwise axis 232 of the first rail 162, the lengthwise axis 234 of the second rail 164, the lengthwise axis 238 of the third rail 168, the lengthwise axis (not shown) of the bracket 226, the lengthwise axis (not shown) of the housing 210, and/or the lengthwise axis (not shown) of the first portion 264.

In some implementations with more than one louver 202, 204, the third gear 310 may be any body capable of inducing rotation of more than one louver 202, 204. In some implementations, the third gear 310 may be a translating body in which at least a portion of the translating body translates along the translation axis 330. Depending on the implementation, the third gear may have any size and/or shape and may have any structure such as a rack, a timing belt, a chain, cable, central rod, and/or gear train. In implementations in which the third gear 310 is a timing belt, the third gear 310 may be any type of belt such as a toothed belt and/or cambelt. The belt may include at least one cog that may be configured to engage at least one cog of the first gear 314 and/or the second gear 320. In implementations in which the third gear 310 is a chain, the third gear 310 may be any type of chain such as a linked chain. The chain may be configured to engage with at least one chain link at least one cog of the first gear 314 and/or the second gear 320.

The first gear 314 may include one or more cog 316 which may engage with the one or more cog 312. In some implementations, two cogs 316 may be sized and/or shaped to receive a cog 312. In some implementations, there may be sufficient clearance between the size of a cog 316 and a cog 312 such that the gear train 360 suffers less wear from mechanical stress. The first gear 314 may be coupled to a first narrow portion 318 of the first pivot base 302 of the first louver 202. The first narrow portion 318 may have a consistent or variable diameter and may have a diameter less than the inner diameter of the first gear 314 such that the first gear may rotate about the first narrow portion 318 and the first pivot base 302. In some implementations, the first gear 314 may be at least partially hollow to reduce material stress and/or to reduce material cost. In some implementations, the hollow portions of the first gear 314 may include at least one fillet and/or chamfer. In some implementations, there may be additional features added to the first gear 314, and/or subsequent gears such as gears 320, 310, that allow indexing the gears such as gears 314, 320, 310 into a preset position for aiding in assembly of the louver assembly 200.

The second gear 320 may include one or more cog 322 which may engage with the one or more cog 312. In some implementations, two cogs 322 may be sized and/or shaped to receive a cog 312. In some implementations, there may be sufficient clearance between the size of a cog 322 and a cog 312 such that the gear train 360 suffers less wear from mechanical stress. The second gear 320 may be coupled to a second narrow portion 324 of the second pivot base 342 of the second louver 204. The second narrow portion 324 may have a consistent or variable diameter and may have a diameter less than the inner diameter of the second gear 320 such that the first gear may rotate about the second narrow portion 324 and the second pivot base 342. In some implementations, the second gear 320 may be at least partially hollow to reduce material stress and/or to reduce material cost. In some implementations, the hollow portions of the second gear 320 may include at least one fillet and/or chamfer.

The first louver 202 may further include the first pivot base 302, a first slat portion 304, and a first lower collar 308. The first pivot base 302 may extend along a first pivot axis 332 of the first louver 202 between the first gear 314 and a first surface 364 of the first portion 264 of the second rail 164. In some implementations, the first pivot axis 332 may also be referred to as a first axis or any other suitable term. The first pivot base 302 may include the first narrow portion 318 which may couple with the first gear 314. The first slat portion 304 may extend from the first pivot base 302 in at least one direction. In the example shown in FIG. 3, two first slat portions 304 extend from the first pivot base 302. In some implementations, the first slat portion 304 may be wholly or substantially flat and may have a significantly larger surface area on two sides compared to its remaining sides. The first lower collar 308 may couple on an end of the first pivot base 302 between a central portion of the first pivot base 302 and the first surface 364. The first lower collar 308 may be configured to act as a buffer between the first pivot base 302 and the first surface 364.

The second louver 204 may further include the second pivot base 342, a second slat portion 344, a second upper collar 350, and a second lower collar 348. The second pivot base 342 may extend along a second pivot axis 334 of the second louver 204 between the second gear 320 and the first surface 364 of the first portion 264 of the second rail 164. In some implementations, the second pivot axis 334 may also be referred to as a second axis or any other suitable term. The second pivot base 342 may include the second narrow portion 324 which may couple with the second gear 320. The second slat portion 344 may extend from the second pivot base 342 in at least one direction. In the example shown in FIG. 3, two second slat portions 344 extend from the second pivot base 342. In some implementations, the second slat portion 344 may be wholly or substantially flat and may have a significantly larger surface area on two sides compared to its remaining sides. The second upper collar 350 may couple on an end of the second pivot base 342 between a central portion of the second pivot base 342 and the housing 210. The second upper collar 350 may be configured to act as a buffer between the second pivot base 342 and the housing 210. The second lower collar 348 may couple on an end of the second pivot base 342 between a central portion of the second pivot base 342 and the first surface 364. The second lower collar 348 may be configured to act as a buffer between the second pivot base 342 and the first surface 364.

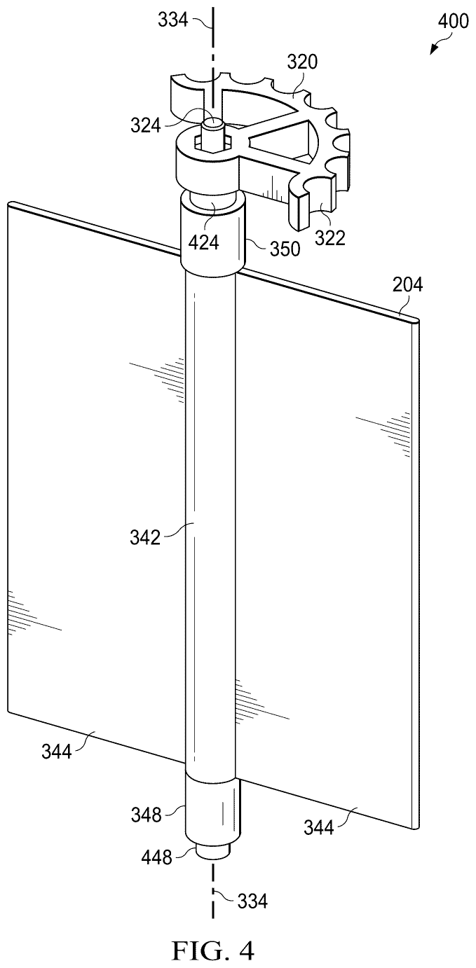

FIG. 4 is a front perspective view of an example louver, according to some aspects of the present disclosure. In some implementations, the gear train 360 may be configured in the upper position or in other implementations, the louver subassembly 200 may be inverted with the gear train 360 in the lower position. In the example shown in FIG. 4, the secondary louver subassembly 400 includes at least the second louver 204 and the second gear 320. The secondary louver subassembly 400 may further include a second intermediate portion 424 and a third narrow portion 448. The second intermediate portion 424 may be positioned between the second narrow portion 324 and the second upper collar 350 and/or the central portion of the second pivot base 342. The second intermediate portion 424 may have a consistent or variable diameter and may have a greatest outer diameter more than the second narrow portion 324 and/or less than the second upper collar 350 and/or a central portion of the second pivot base 342. In some implementations, the greatest outer diameter of the second intermediate portion 424 may be greater than the inner diameter of the second gear 320 such that the second gear 320 may rest on the second intermediate portion 424.

The third narrow portion 448 may be positioned at an end of the second pivot base 342. In some implementations, the third narrow portion 448 may also be positioned adjacent to the second lower collar 348. The third narrow portion 448 may be configured to engage with the first surface 364 of the first portion 264 of the second rail 164. Thus, the third narrow portion 448 may have a consistent or variable diameter and may have a greatest outer diameter less than the diameter of a corresponding hole in the first surface 364 such that the third narrow portion 448 and the second pivot base 342 may couple with the first portion 264. The greatest outer diameter of the third narrow portion 448 may have sufficient clearance with respect to the corresponding hole in the first surface 364 such that the second louver 204 may rotate freely with respect to the first portion 264.

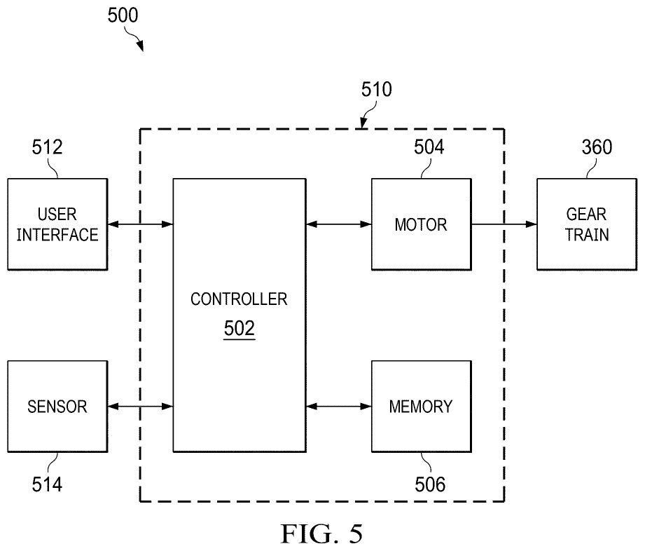

FIG. 5 illustrates an example block diagram of an example louver operator system 500, according to some aspects of the present disclosure. The operator system 500 depending on the implementation may include some or all of a controller 502, a motor 504, a memory 506, at least one user interface 512, and at least one sensor 514. In some implementations, the controller 502, the motor 504, and/or the memory may be positioned in a control box 510 which, in some implementations, may be positioned on a panel 192, 194 of the movable barrier 190.

In some implementations, the motor 504 may be carried on the movable barrier 190. In some implementations, the motor 504 may further be carried on a panel 192, 194 of the movable barrier 190. In some implementations, the motor 504 may further be carried on the first rail 162, the second rail 164, the third rail 168, a stile 160, within the housing 210, and/or on any of the louvers 202, 204. Thus, in some implementations, the motor 504 may be located near the gear train 360 and/or the louvers 202, 204 allowing the motor 504 to be carried on and move with the movable barrier as it opens and/or closes and/or the panel 192, 194 rotates and/or pivots. The motor 504 may be configured to actuate the gear train 360. Thus, the motor 504 may cause the gear train 360 to move the louvers 202, 204 from the closed configuration to the open configuration and/or from the open configuration to the closed configuration. In some implementations, the motor 504 may cause the gear train to rotate the louvers 202, 204 to one or more pre-determined or entered angle offsets based on an initial reference position. In some implementations, the motor 504 may create a rotational movement which may rotate at least a portion of the gear train 360 such as a belt, chain, gear, sprocket, pinion, and/or cam. In some implementations, the motor 504 may create a translational movement which may cause at least a portion of the gear train 360 such as a rack (e.g., a rack included in a rack and pinion system) to translate. In some implementations, the motor may have one output speed and/or one reverse output speed. In some implementations, the motor may be configured to vary its output speed and/or power over time and/or in response to input from the controller 502. In some implementations, the motor 504 may have a rotating portion (not shown) capable of causing rotation of a body such as at least a portion of the gear train 360.

In some implementations, the controller 502 may actuate the motor 504 to move the gear train 360. In some implementations, the controller 502 may receive a signal and in response to the signal, cause the motor 504 (e.g., the controller may start or stop the motor) to cause the gear train to move the louvers 202, 204 from the closed configuration to the open configuration and/or from the open configuration to the closed configuration. In some implementations, the controller 502 may receive an input signal and in response to the signal, cause the motor 504 to cause the gear train 360 to rotate the louvers 202, 204 to one or more pre-determined or entered angle offsets based on an initial reference position. The controller 502 may receive a signal from any source, such as one or more user interfaces 512 and/or one or more sensors 514. In some implementations, the controller 502 may be configured to cause the motor 504 to vary its output speed and/or power over time and/or in response to received input signals.

In some implementations, one or more user interfaces 512 may be configured to send one or more signals to the controller 502 to cause the motor 504 to actuate the gear train 360. In some implementations, the user interface 512 may be a switch which may toggle the louver assembly 200 between a closed configuration and an open configuration. In some implementations, the user interface 512 may be a switch which may toggle the motor 504 between settings such as a forward setting, a neutral or off setting, and a reverse setting. In some implementations, the user interface 512 may be a control system which may allow a user to control one or more settings including, for example, adjusting one or more pre-determined or entered angle offsets of the louvers 202, 204 based on an initial reference position and/or adjusting motor 504 settings, such as speed and/or power. The user interface 512 may be any type of user-operable control such as a switch, joystick, control panel, remote, touchscreen, computer program, and/or mobile device. In some implementations, the user interface 512 may signal to the controller 502 to actuate the motor 504 while in other implementations, the user interface 512 may actuate the motor 504 directly.

In some implementations, one or more sensors 514 may be configured to send one or more signals to the controller 502 to cause the motor 504 to actuate the gear train 360. In some implementations, the sensor 514 may be configured to send a binary output which may toggle the louver assembly 200 between a closed configuration and an open configuration. In some implementations, the sensor 514 may be configured to send a binary output which may toggle the motor 504 between a forward setting and a reverse setting. In some implementations, the sensor 514 may be configured to send multiple signals to adjust one or more pre-determined or entered angle offsets of the louvers 202, 204 based on an initial reference position. The sensor 514 may be any type of sensor such as a photosensor, a motion sensor, an object sensor, a noise sensor, a voice sensor, a temperature sensor, a force sensor, and/or a pressure sensor. In implementations including more than one sensor 514, the operator system 500 may include two or more different types of sensors. In some implementations including a photosensor, the sensor 514 may cause the louvers 202, 204 to position in either the closed configuration or the open configuration based on the amount of light received by the sensor. In some implementations including a photosensor, the sensor 514 may cause the louvers 202, 204 to gradually or periodically shift position based on changing light levels in an environment, such as changing light levels from a sun throughout a day. For example, a photosensor may sense an increased light level in a morning and cause the louver assembly 200 to open and/or a photosensor may sense a decreased light level in an evening and cause the louver assembly 200 to close. In some implementations including, for example, a motion sensor and/or an object sensor, the sensor may cause the louvers 202, 204 to shift to a closed configuration or an open configuration based on sensed movement or a sensed object in an environment. For example, a motion sensor and/or an object sensor may sense when a person and/or object enters a room and cause the louver assembly 200 to open or close. In some implementations, the sensor 514 may signal to the controller 502 to actuate the motor 504 while in other implementations, the sensor 514 may actuate the motor 504 directly. In some implementations, the sensor 514 may be a timer. For example, a timer may cause the louver assembly 200 to open or close based on a time or time interval. For example, a timer may cause a louver assembly 200 to open during business hours (e.g., 8:00 AM to 5:00 PM) and close outside of business hours.

In some implementations, the memory 506 may be configured to store any type of data, information, and/or settings. In some implementations, the memory 506 may be configured to store one or more settings, such as times and/or light levels to activate the louver assembly 200, one or more pre-determined or entered angle offsets of the louvers 202, 204 based on an initial reference position, and/or motor 504 settings, such as speed and/or power. The controller 502 may be configured to store data and/or settings in the memory 506 and/or the user interface 512 and/or the sensor 514 may be configured to store data and/or settings in the memory directly. In some implementations, the memory 506 may store times of day and/or time intervals which may be sent to the controller to actuate the louver assembly.

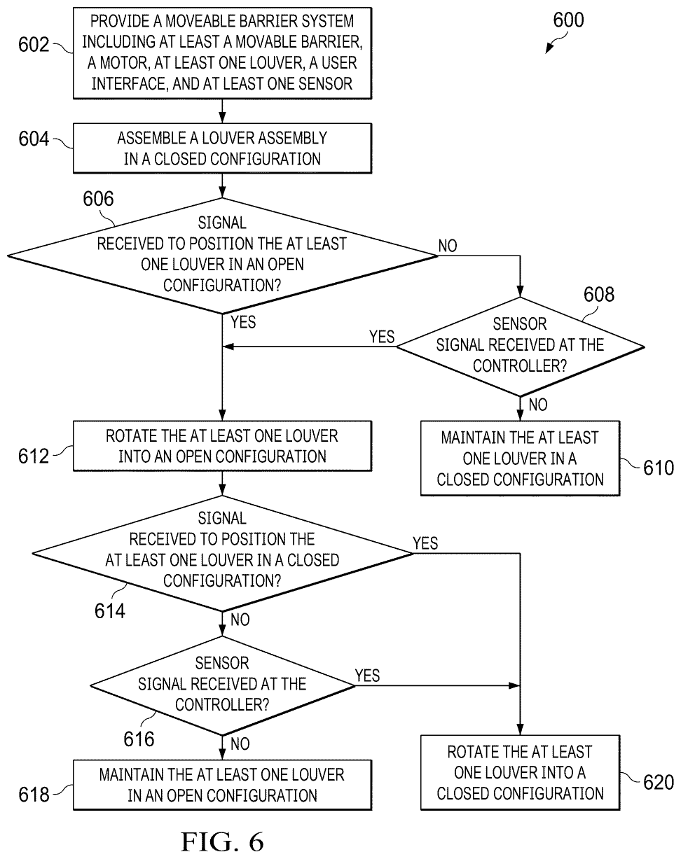

FIG. 6 illustrates an example method of adjusting louvers at a window and/or an opening in a movable barrier system, according to some aspects of the present disclosure. In this way, the method can adjust lighting or visibility through the window or opening. At process 602, a movable barrier system may be provided including at least some or all of a movable barrier 190, a motor 504, at least one louver 202, 204, a user interface 512, and/or at least one sensor 514. At process 604, a louver assembly may be disposed in a closed configuration for purposes of this control example.

At optional process 606, the controller 502 may receive a signal from the user interface 512 to position at least one louver in an open configuration. If the controller 502 receives the signal from the user interface 512, the method 600 may proceed to process 612. If the controller 502 does not receive the signal from the user interface 512, the method 600 may proceed to process 608.

At optional process 608, the controller 502 may receive a signal from the sensor 514 to position at least one louver in an open configuration. If the controller 502 receives the signal from the sensor 514, the method 600 may proceed to process 612. If the controller 502 does not receive the signal from the sensor 514, the method 600 may proceed to process 610.

At process 610, the louver 202 or the louvers 202, 204 may be maintained in a closed configuration.

At process 612, the controller 502 may cause the motor 504 to cause the gear train 360 to rotate the louver 202 or the louvers 202, 204 into an open configuration.

At optional process 614, the controller 502 may determine if the user interface 512 has sent a signal to position at least one louver in a closed configuration. If the controller 502 receives the signal from the user interface 512, the method 600 may proceed to process 620. If the controller 502 does not receive the signal from the user interface 512, the method 600 may proceed to process 616.

At optional process 616, the controller 502 may determine if the sensor 514 has sent a signal to position at least one louver in a closed configuration. If the controller 502 receives the signal from the sensor 514, the method 600 may proceed to process 620. If the controller 502 does not receive the signal from the sensor 514, the method 600 may proceed to process 618.

At process 618, the louver 202 or the louvers 202, 204 may be maintained in an open configuration.

At process 620, the controller 502 may cause the motor 504 to cause the gear train 360 to rotate the louver 202 or the louvers 202, 204 into a closed configuration.

It should be appreciated that any of the processes of method 600 may be completed in any order. It should also be appreciated that some or all optional steps may be completed depending on the implementation. The order of the steps in method 600 may be changed indiscriminately as the operator system 500 operates the louver assembly 200.

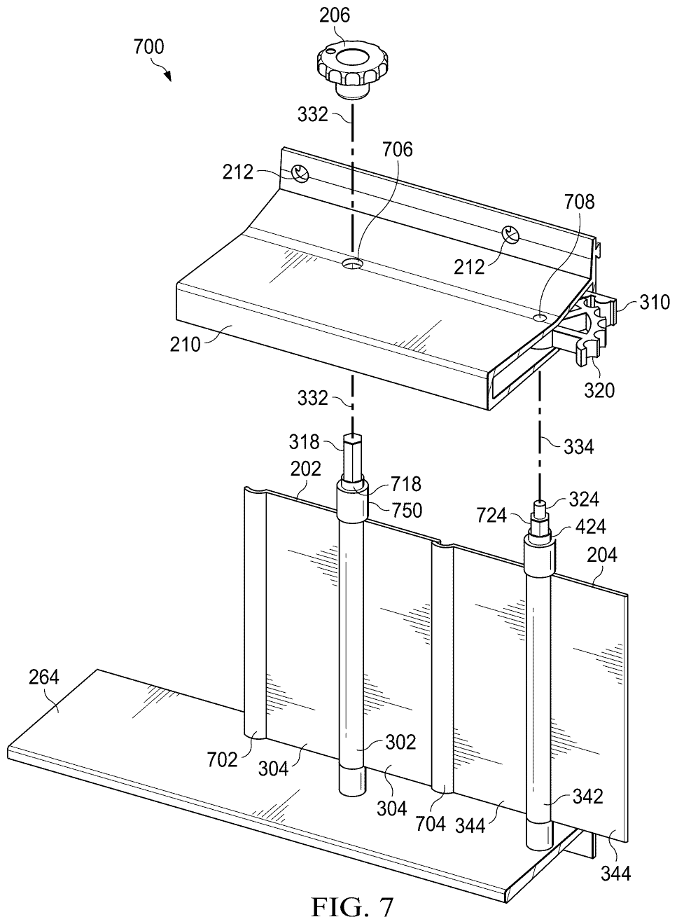

FIG. 7 is an exploded front perspective view of an example louver assembly, according to some aspects of the present disclosure. In some implementations, the gear train 360, knob 206, controller 502, motor 504, and/or user interface 512 may be installed vertically on the top of the louver assembly 200, while in other implementations, the louver assembly 200 may be inverted with the gear train 360, knob 206, controller 502, motor 504, and/or user interface 512 positioned on the bottom of the louver assembly 200. In some implementations, the one or more louvers 202, 204 may be mounted horizontally with the gear train 360, knob 206, controller 502, motor 504, and/or user interface 512 positioned on the left or the right sides of the louver assembly 200. In some implementations, the second slat portion 344 may include a second indented portion 704, which may extend from a side of the second slat portion 344. At a specific orientation of the second louver 204, the second indented portion 704 may couple with the first slat portion 304 allowing the first slat portion 304 to align with the second slat portion 344. Thus, when the louver assembly 200 is in a fully closed configuration, the second indented portion 704 may allow the second louver 204 to be aligned at the same offset angle as the first louver 202. Thus, the second indented portion 704 may allow for the louver assembly 200 to shift from a shiplap configuration to a flush configuration. It should be understood that the second indented portion 704 may be any shape and/or size as long as it allows the first slat portion 304 to align with the second slat portion 344. In some implementations, the second indented portion 704 may be formed by joggle bending of the second slat portion 344. In some implementations, the second indented portion 704 may restrict light and/or viewing between any space between the first louver 202 and the second louver 204.

In some implementations, the first slat portion 304 may include a first indented portion 702 that may be sized and shaped similarly to the second indented portion 704. In some implementations, the first indented portion may couple with a stile 160 or an adjacent bracket and/or may allow the first louver 202 to rotate further with respect to a stile 160 or an adjacent bracket. Thus, in some implementations, the first indented portion 702 may in conjunction with the second indented portion 704 allow for the louver assembly 200 to shift from a shiplap configuration to a flush configuration. In some implementations, the first indented portion 702 may be formed by joggle bending of the first slat portion 304.

In some implementations, the housing 210 may further include a first hole 706 and a second hole 708. The first hole 706 may be configured to couple with the first narrow portion 318 and/or may be adjacent to the knob 206 and/or the first gear 314. In some implementations, the first hole 706 may be threaded. The first hole 706 may be any size and/or shape such as circular and/or hexagonal. The second hole 708 may be configured to couple with the second narrow portion 324 and/or may be adjacent to the second gear 320. In some implementations, the second hole 708 may be threaded. The second hole 708 may be any size and/or shape such as circular and/or hexagonal.

In some implementations, the first pivot base 302 may further include a first upper collar 750. The first upper collar 750 may couple on an end of the first pivot base 302 between a central portion of the first pivot base 302 and the housing 210. The first upper collar 750 may be configured to act as a buffer between the first pivot base 302 and the housing 210.

In some implementations, the first pivot base 302 may further include a first intermediate portion 718. The first intermediate portion 718 may be positioned between the first narrow portion 318 and the first upper collar 750 and/or the central portion of the first pivot base 302. The first intermediate portion 718 may have a consistent or variable diameter and may have a greatest outer diameter more than the first narrow portion 318 and/or less than the first upper collar 750 and/or a central portion of the first pivot base 302. In some implementations, the greatest outer diameter of the first intermediate portion 718 may be greater than the inner diameter of the first gear 314 such that the first gear 314 may rest on the first intermediate portion 718.

In some implementations, the second pivot base 342 may further include a second narrow intermediate portion 724. The second narrow intermediate portion 724 may be positioned between the second narrow portion 324 and the second intermediate portion 424. The second narrow intermediate portion 724 may have a consistent or variable diameter and may have a greatest outer diameter more than the second narrow portion 324 and/or less than the second intermediate portion 424. In some implementations, the greatest outer diameter of the second narrow intermediate portion 724 may be greater than the inner diameter of the second gear 320 such that the second gear 320 may rest on the second narrow intermediate portion 724.

It should be understood that although implementations in this disclosure may be referred to with words such as “upper,” lower,” “downwardly,” and “upwardly,” all implementations disclosed herein may be configured in any orientation and/or direction.

Persons skilled in the art will recognize that the apparatus, systems, and methods described above can be modified in various ways. Accordingly, persons of ordinary skill in the art will appreciate that the embodiments encompassed by the present disclosure are not limited to the particular exemplary embodiments described above. In that regard, although illustrative embodiments have been shown and described, a wide range of modification, change, and substitution is contemplated in the foregoing disclosure. It is understood that such variations may be made to the foregoing without departing from the scope of the present disclosure. Accordingly, it is appropriate that the appended claims be construed broadly and in a manner consistent with the present disclosure.

What is claimed is:

1. A louver system for a panel of a movable barrier, the louver system comprising:
a first louver carried on the panel of the movable barrier and comprising a first slat portion pivotable about a first axis;
a second louver carried on the panel of the movable barrier and offset from the first louver, the second louver comprising a second slat portion pivotable about a second axis;
a gear train configured to simultaneously rotate the first louver about the first axis and the second louver about the second axis between an open configuration and a closed configuration; and
a motor carried on the movable barrier and configured to drive the gear train to simultaneously rotate the first louver and the second louver.

2. The louver system of claim 1, wherein the gear train comprises:
a first gear associated with the first louver and configured to rotate the first louver relative to the movable barrier, the first gear having a cog;
a second gear associated with the second louver and configured to rotate the second louver relative to the movable barrier, the second gear having a cog; and
a third gear configured to engage the cog of the first gear and the cog of the second gear, at least a portion of the third gear being configured to translate along a translation axis in a manner that causes the first gear and the first louver to rotate about the first axis and causes the second gear and the second louver to rotate on the second axis.

3. The louver system of claim 1, wherein the second slat portion comprises an indented portion, the indented portion being configured to couple with the first slat portion in a manner that an axis of the first slat portion and an axis of the second slat portion may both be substantially parallel to a translation axis in the closed configuration.

4. The louver system of claim 1, further comprising a controller and a user interface, the user interface configured to send a signal to the controller, the controller configured to start or stop the motor based on the signal.

5. The louver system of claim 1, further comprising a controller and a sensor, the sensor configured to send a signal to the controller, the controller configured to start or stop the motor based on the signal.

6. The louver system of claim 2, wherein the third gear further comprises a belt configured to engage with a rotating portion of the motor in a manner that the motor causes at least a portion of the belt to translate along the translation axis.

7. The louver system of claim 2, wherein when the louver system is in the closed configuration, an axis of the first slat portion and an axis of the second slat portion both being offset at a first angle from the translation axis; and
wherein when the louver system is in the open configuration, the axis of the first slat portion and the axis of the second slat portion both being offset at a second angle from the translation axis, the second angle being greater than the first angle.

8. A movable barrier system comprising:
a movable barrier panel comprising a first rail and a second rail, the second rail being disposed at a position spaced a distance apart from the first rail;
a first louver coupled to the second rail and comprising a first slat portion and a first pivot base;
a second louver coupled to the second rail and offset from the first louver, the second louver comprising a second slat portion and a second pivot base;
a gear train coupled to the first pivot base and the second pivot base, the gear train configured to simultaneously rotate the first louver and the second louver between an open configuration and a closed configuration; and
a motor carried on the first rail and configured to drive the gear train to simultaneously rotate the first louver and the second louver.

9. The movable barrier system of claim 8, wherein the gear train comprises:
a first gear associated with the first pivot base and configured to rotate the first pivot base relative to the second rail, the first gear having a cog;
a second gear associated with the second pivot base and configured to rotate the second pivot base relative to the second rail, the second gear having a cog; and
a third gear configured to engage the cog of the first gear and the cog of the second gear, at least a portion of the third gear being configured to translate along a translation axis in a manner that causes the first gear and the first pivot base to rotate on a first axis of rotation substantially perpendicular to the translation axis and causes the second gear and the second pivot base to rotate on a second axis of rotation substantially perpendicular to the translation axis, the translation axis being substantially parallel to the first rail.

10. The movable barrier system of claim 8, wherein the second slat portion comprises an indented portion, the indented portion being configured to couple with the first slat portion in a manner that an axis of the first slat portion and an axis of the second slat portion may both be substantially parallel to a translation axis in the closed configuration.

11. The movable barrier system of claim 8, further comprising a controller and a user interface, the user interface configured to send a signal to the controller, the controller configured to start or stop the motor based on the signal.

12. The movable barrier system of claim 8, further comprising a controller and a sensor, the sensor configured to send a signal to the controller, the controller configured to start or stop the motor based on the signal.

13. The movable barrier system of claim 9, wherein the third gear further comprises a belt, the belt configured to engage with a rotating portion of the motor in a manner that the motor causes at least a portion of the belt to translate along the translation axis.

14. The movable barrier system of claim 9, wherein when the movable barrier system is in the closed configuration, an axis of the first slat portion and an axis of the second slat portion both being offset at a first angle from the translation axis; and
wherein when the movable barrier system is in the open configuration, the axis of the first slat portion and the axis of the second slat portion both being offset at a second angle from the translation axis, the second angle being greater than the first angle.

15. A method for adjusting a louver system for a panel of a movable barrier, the method comprising:
positioning a first louver on the panel of the movable barrier, the first louver comprising a first slat portion pivotable about a first axis;
positioning a second louver on the panel of the movable barrier offset from the first louver, the second louver comprising a second slat portion pivotable about a second axis;
coupling a gear train to the first louver and the second louver, the gear train configured to simultaneously rotate the first louver and the second louver between an open configuration and a closed configuration;
positioning a motor on the movable barrier, the motor configured to drive the gear train to simultaneously rotate the first louver and the second louver; and
sending a signal to a controller to cause the motor to drive the gear train to simultaneously rotate the first louver and the second louver.

16. The method of claim 15, wherein the gear train comprises:
a first gear associated with a first pivot base and configured to rotate the first pivot base relative to the movable barrier, the first gear having a cog;
a second gear associated with a second pivot base and configured to rotate the second pivot base relative to the movable barrier, the second gear having a cog; and
a third gear configured to engage the cog of the first gear and the cog of the second gear, at least a portion of the third gear being configured to translate along a translation axis in a manner that causes the first gear and the first pivot base to rotate on a first axis of rotation substantially perpendicular to the translation axis and causes the second gear and the second pivot base to rotate on a second axis of rotation substantially perpendicular to the translation axis.

17. The method of claim 15, wherein the second slat portion comprises an indented portion, the indented portion being configured to couple with the first slat portion in a manner that an axis of the first slat portion and an axis of the second slat portion may both be substantially parallel to a translation axis in the closed configuration.

18. The method of claim 15, further comprising providing a controller and a user interface, the user interface configured to send a signal to the controller, the controller configured to start or stop the motor based on the signal.

19. The method of claim 15, further comprising providing a controller and a sensor, the sensor configured to send a signal to the controller, the controller configured to start or stop the motor based on the signal.

20. The method of claim 16, wherein the third gear further comprises a belt, the belt configured to engage with a rotating portion of the motor in a manner that the motor causes at least a portion of the belt to translate along the translation axis.
